(19) United States
(12) Patent Application Publication
(10) Pub. No.: US 2010/0042375 A1
(43) Pub. Date: Feb. 18, 2010

(54) System and Method for Designing Proteins

(75) Inventors: George N. Phillips, JR., Madison, WI (US); Ryan M. Bannen, Madison, WI (US); Euiyoung Bae, Oakland, WI (US); Vanitha Suresh, Madison, WI (US); Stephen J. Wright, Madison, WI (US)

Correspondence Address: WHYTE HIRSCHBOECK DUDEK S.C./WARF;INTELLECTUAL PROPERTY DEPARTMENT, 555 East Wells Street, Suite 1900, Milwaukee, WI, 53202, US

(73) Assignee: WISCONSIN ALUMNI RESEARCH FOUNDATION, Madison, WI (US)

(21) Appl. No.: 12/188,853

(22) Filed: Aug. 8, 2008

Related U.S. Application Data
(60) Provisional application No. 60/954,715, filed on Aug. 8, 2007.

(51) Int. Cl. G06F 17/50; G06F 17/11

(52) U.S. Cl. 703/1; 703/2

(57) ABSTRACT

Various embodiments of the present invention include systems and methods for redesigning proteins. Various embodiments of the present invention present bioinformatic methods to redesign proteins to be more stable through optimization of local structural entropy. The redesigned proteins display significant increases in their thermal stabilities while retaining catalytic activity, and demonstrate a broadly applicable method.

### CROSS REFERENCE TO RELATED APPLICATIONS

The present application claims priority to U.S. Provisional Patent Application Ser. No. 60/954,715, filed Aug. 8, 2007, and titled System and Method for Designing Proteins, which is fully incorporated herein by reference.

### STATEMENT REGARDING FEDERALLY SPONSORED RESEARCH OR DEVELOPMENT

This invention was made in-part with United States Government support awarded by the following agency: DOE training grant #DE-FG02-04ER25627 and NIH grant #GM074901.

### FIELD OF THE INVENTION

Generally the present invention relates to protein analysis and design. More specifically, various embodiments of the present invention involve methods and systems for designing thermostable proteins.

### BACKGROUND OF THE INVENTION

For many biotechnological purposes, it is desirable to redesign proteins for stability at higher temperatures. By example, chemical reactions are intrinsically faster at higher temperatures and using enzymes that are stable at higher temperatures would lead to more efficient industrial processes. Various studies have been performed to find principles of protein thermostabilization and apply them for rationally engineering proteins. Such methods include comparative studies using thermophilic and mesophilic homologues. These methods provide individual structural features, but they are used unpredictably to different extents and in different proteins. In addition, methods including directed evolution have been used to improve protein thermostability. However, there are significant limitations, including labor intensive methods and expensive processes involved with directed evolution of proteins.

Recent computationally focused methods for designing thermally stable proteins often require three-dimensional protein structures. One sequence-based methodology for engineering proteins with greater thermostability is a so-called consensus sequence-based approach. This approach is based upon a hypothesis that in a given position in alignment of multiple homologous sequences, the consensus amino acid contributes to stability more than the non-consensus one. Although this method does not need structural information, it requires a significant number of homologous sequences for extensive sequence analysis. This often involves arbitrary constraints in deciding mutations, which can cause differences in success rates.

It would be advantageous for a system and method to provide an approach to design thermally stable proteins using as few as one target sequence and one homologous sequence. It would be a further advantage empirically to use the local structural entropy (LSE) of a protein sequence guided by simple sequence alignment for designing thermally stable proteins.

### SUMMARY OF THE INVENTION

In at least one embodiment, the present invention is a method for designing thermostable proteins using computers, including the steps of identifying a target protein sequence, identifying at least one homologous sequence of the base protein sequence, generating a list of conserved residues between the base sequence and homologous sequence, and generating a list of allowable substitution positions based upon function and structure criteria of the base sequence. Additionally, the steps of generating a list of all possible chimera sequences based upon the allowable substitutions; calculating a local structural entropy value for each chimera sequence, the chimera sequences are ordered based upon the local structure entropy value; and selecting a target sequence having a greater thermostability than the base sequence.

In another embodiment, the present invention is a protein sequence identified by a process, at least partially implemented on a computer system, for designing a thermostable protein. The process includes the steps of comparing a base protein sequence to a homologous protein sequence, generating a list of conserved residues between the target sequence and homologous sequence, generating a list of allowable substitution positions based upon function and structure criteria of the base sequence, generating a shortest path network for identifying the most thermostable chimera sequences based upon the allowable substitutions, calculating an LSE value for each tetramer within the network, and selecting a target sequence having an optimal local structural entropy value, wherein the target sequence represents the shortest path through the network.

### BRIEF DESCRIPTION OF THE DRAWINGS

FIG. 1 is an exemplary flow diagram of a method for designing proteins in accordance with at least one embodiment of the present invention;

FIG. 2 is an expanded flow diagram of one step present in FIG. 1, in accordance with at least one embodiment of the present invention;

FIG. 3 is an expanded flow diagram of another step present in FIG. 1, in accordance with at least one embodiment of the present invention;

FIG. 4 is a flow diagram representing an example of the shortest path algorithmic approach in accordance with at least one embodiment of the present invention;

FIG. 5 is an activity profile including 4 different Adenylate Kinase sequences, in accordance with at least one embodiment of the present invention; and

FIG. 6 is melting curve (Tm) plot of three Adenylate Kinases, in accordance with at least one embodiment of the present invention.

### DETAILED DESCRIPTION OF THE INVENTION

Various embodiments of the present invention utilize an empirical descriptor known as the local structural entropy (LSE) in a protein sequence guided by simple sequence alignment. Various embodiments of the present invention include a methodology having a single alignment set of homologous sequences for a base protein. Conserved residues are identified and a set of allowable substitutions within variable residues, which do not affect overall folding or function, is generated. At each variable position an amino acid is chosen from the allowed set to make a protein sequence with the optimal or lowest LSE. LSE values for all possible protein segments of length four are calculated based on their structural diversity found in the Protein Data Bank (PDB) (www.pdb.org). At least one embodiment of the present invention dynamically retrieves information from the PDB, or an alternative protein database, on a predetermined regular time interval.

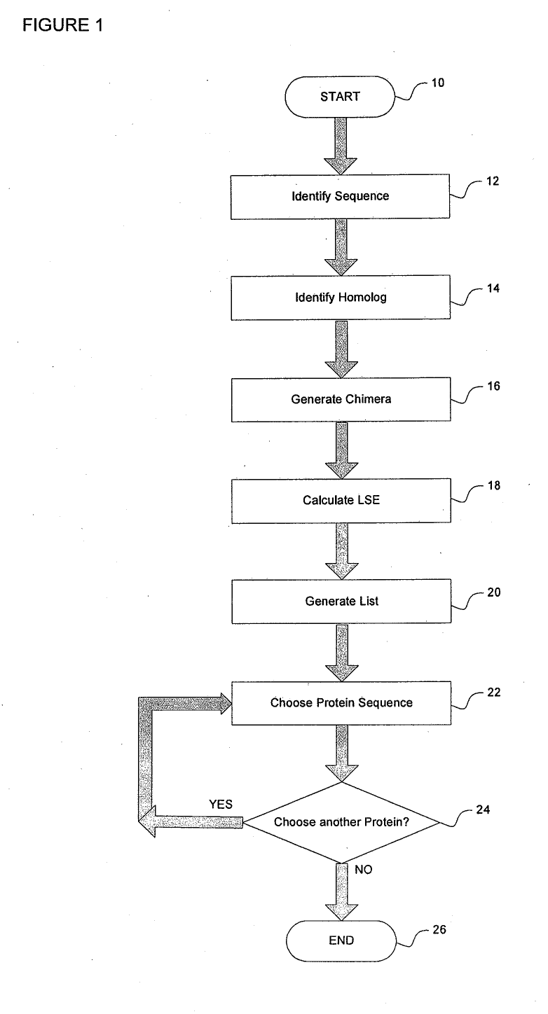

Now referring to FIG. 1, a flow diagram provides an exemplary process for designing thermostable proteins. The process is initiated at step 10 and a base protein sequence is chosen at step 12. At least one homolog of the selected protein is identified at step 14. A list of chimera protein sequences is generated at step 16. After the list of chimera sequences is generated, the local structural entropy (LSE) for each chimera sequence is calculated at step 18. A list of the LSE values is generated at step 20 and a chimera protein sequence is chosen at step 22. If another target protein is desired, then step 22 is repeated. If another target protein is not desired, then the process is terminated at step 26. The target protein is the protein sequence resulting from substitutions made to either the base protein or one of the homologous proteins.

Homologous protein sequences are two or more sequences that share a similar sequence and have similar function. After choosing a base protein sequence a homologous sequence can be identified by performing a sequence search. By example, the Basic Local Alignment Search Tool (BLAST) can be used to dynamically identify homologues. Greater than one homologue can be used to design thermo stable proteins in accordance with at least one embodiment of the present invention.

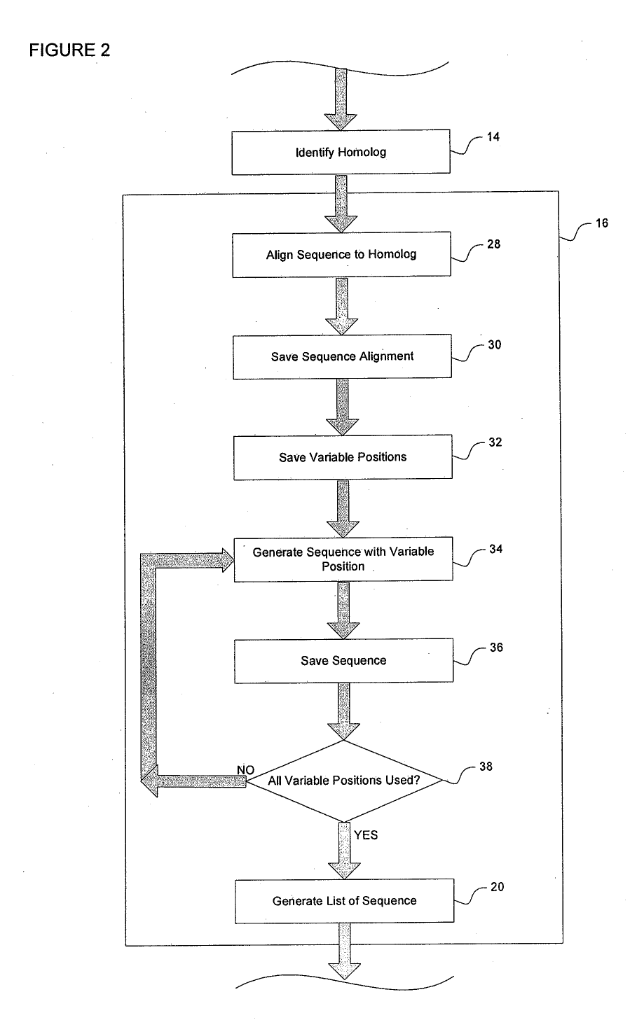

Referring to FIG. 2, the chimera generation step 16 is provided in greater detail. After the homologous sequence is identified at step 14 the base sequence and homologous sequence are aligned at step 28. Alternatively, more than one homologous sequence can be identified, and a sequence alignment can be performed between the base sequence and more than one homologous sequence. A file containing the aligned sequence data is generated and saved to a memory device at step 30 and a file containing variable position data is generated and saved to a memory device at step 32. A list of theoretical protein chimeras is generated at step 34 for each particular variable position. The list of chimeras is saved to memory at step 36. If all variable positions have been used to generate the list of chimeras at step 34, then a list of all potential chimeras is generated at step 20. Step 34 is repeated if all the variable positions have not been used to generate potential chimera sequences. Variable positions are locations in the base protein sequence where allowable substitutions can be made.

The list of protein chimeras includes sequences for all potential chimeras according to the variable positions. Based upon the limited variable positions and a total of 20 possible amino acids, there are 19 possible substitutions for each variable position. However, all amino acids substitutions do not have to be allowed, and it is possible to have additional restrictions in selecting amino acids for substitution. Substitutions are allowed if they do not affect folding or protein function such that the target protein doesn't function as the base protein or as intended. Improper substitutions can cause the secondary or tertiary structure of the protein to be significantly changed. Furthermore, some substitutions can alter the overall function of the protein. It is important that the chimeras generated do not exhibit a different function or structure from the selected protein sequence. The number of allowed variable positions can depend upon the particular protein in question. Various proteins can have a range of about 5% to about 15% allowable substitutions as compared to the base sequence. Alternatively, the allowable substitutions can comprise less than about 5% or greater than about 15% of the entire base sequence. Alternatively, the amino acid residue allowable substitutions can comprise greater than or equal to about 10 different amino acid substitution locations.

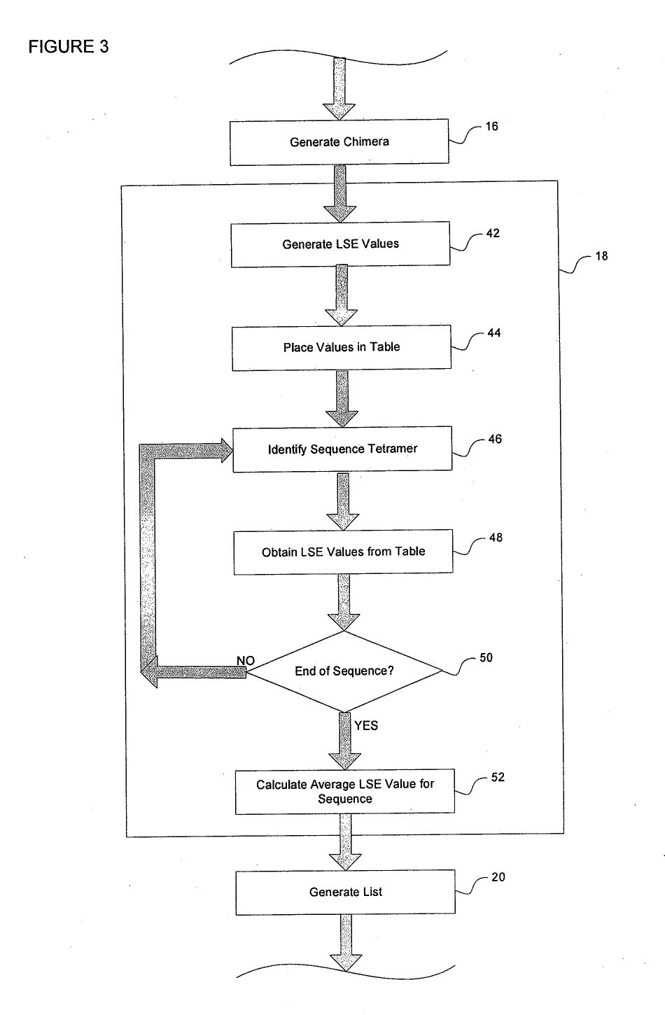

Referring to FIG. 3, LSE values for each protein tetramer are generated at step 42. The LSE values are listed in a look-up table, or a computer library, at step 44. The first protein tetramer for each chimera is identified at step 46 and the LSE value for the tetramer is obtained at step 48 from the look-up table. If the end of the chimera sequence is not reached at step 50, then step 46 is repeated, otherwise the average LSE value for each chimera sequence is generated at step 52. A list of LSE values is then generated at step 20 in order of lowest LSE to highest LSE.

### Generate LSE

The local structural entropy of a given protein sequence can be calculated based upon known secondary structural information for a given amino acid sequence. Alternatively, secondary and other structural data can be theoretically extrapolated for use in calculating the local structural entropy. Segmenting the protein sequence into smaller pieces, such as tetramers, assists with analysis of the local structural entropy. For each tetrapeptide, or tetramer, a value is generated based upon structural information. The value is listed in a table and indexed by the tetramer.

Embodiments of the present invention employ an approach referred to as the Improved Configurational Entropy (ICE) to design more thermally stable proteins based on measures of local structural entropy (LSE). Embodiments of the ICE approach were described by at least one of the inventors in the following publication, which is hereby incorporated by reference in its entirety herein. Bioinformatic method for protein thermal stabilization by structural entropy optimization. Proc Natl Acad Sci USA, 105, 9588-9593 (2008).

At least one embodiment of the present invention automatically updates the tetramer LSE value library on a regular basis. The LSE values are based upon current data available from the PDB. The PDB is regularly updated. It is important for purposes of the present invention that the LSE values be based on the most current data available. An automated process includes accessing the PDB on a pre-determined time schedule, or alternatively, when new data has been entered for a given tetramer. Each of the tetramers listed within the look-up table is accessed in the PDB and then compared with the look-up table data. If the data do not coincide, then the LSE for that particular tetramer is re-calculated and the new data replaces the existing value within the look-up table. The look-up table can also store time-stamp data corresponding to tetramer LSE data, which can be helpful when ascertaining the LSE value on a particular date and time. Sequence structural data are based upon various secondary structure types, which include β-bridges, extended β-sheets, 3₁₀-helices, α-helices, π-helices, bends, turns as well as other structures. Protein segments that can exist equally well in many configurations have higher entropy than those that exist primarily in one or a few secondary structure states. Absolute value from LSE calculations cannot easily be converted to thermodynamic units of entropy, but there is a correlation between thermal stabilities for a given family of proteins and their overall LSE values.

For a given protein sequence, there are a plurality of tetramers. Since the entropy for a particular amino acid residue is based in part upon the values of the neighbor residues, an average of multiple sequences is generated. In the present embodiment, a plurality of four sequence tetramers are used to generate the structural entropy for a particular residue. By example, when calculating the structural entropy for residue G in sequence . . . PLRCTPRGTYLCICI . . . , four possible sequence windows covering the residue include TPRG, PRGT, RGTY, and GTYL. The respective structural entropy values of each tetramer are accessed from the look-up table and an average of the four values is calculated. The structural entropy of G is calculated using Equation Set 1. Variables present in Equation Set 1 are defined within Chan, C. H. et al. Relationship between local structural entropy and protein thermostability. Proteins, 57, 684-91 (2004), which is hereby incorporated by reference in its entirety herein.

$$S = - {\sum }_{j = 1}^{8} {\overline{π}}_{j} ln {\overline{π}}_{j} \qquad Equation Set 1$$

The structural profile library, or look-up table, is generated from a structural database such as a non-redundant PDB set or Structural Classification of Proteins (SCOP) database. The Definition of Secondary Structure of Proteins (DSSP) is also commonly applied. Alternatively, databases having access to similar data and known within the art can be used.

A computer system (not shown) can be used to implement various processes of at least one embodiment of the present invention. Such a computer system includes a processor, graphical user interface, and a memory storage device. Alternatively, a computer network comprising multiple computers having multiple processors can be implemented for executing at least one embodiment of the present invention.

Computationally designing a thermostable protein can involve significant time based upon the complex calculations and significant amount of data processing involved. Given a particular protein sequence where the allowable amino acid substitutions are limited to two (2) and there are fifty five (55) variable positions, there are 2⁵⁵ possible chimera sequences. A “brute-force” exhaustive-enumeration approach would evaluate the LSE for every one of these sequences, a process that would require a significant amount of computational resources. Therefore, the “brute-force” method is a less desirable alternative embodiment of the present invention. However, formulating the method as a network optimization problem allows a chimera with minimum LSE, and hence the target protein, to be identified in a much more computationally efficient manner than the exhaustive approach.

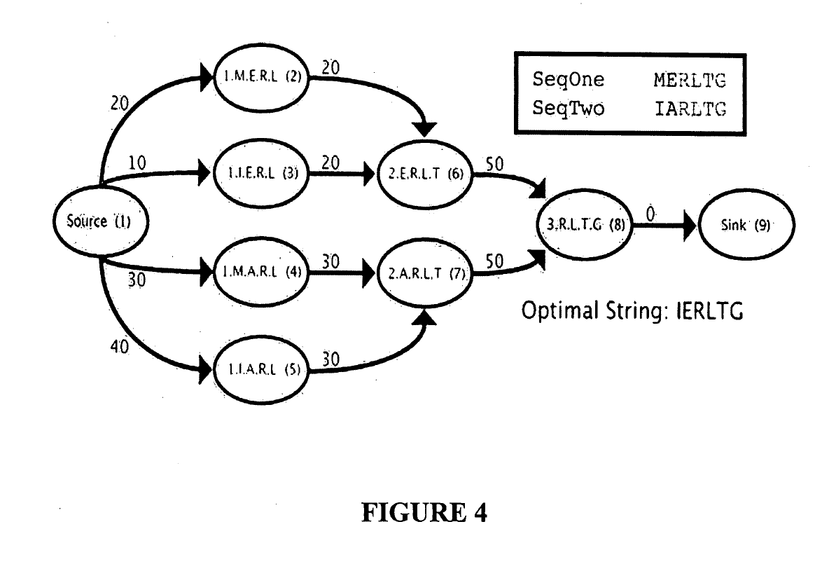

Referring to FIG. 4, an example graph is provided that is assembled by ICE for a short sequence alignment of two short protein sequences shown in the upper-right corner of the figure. The first two residues are non-conserved residues in the alignment. Each node in the graph represents a possible tetramer of amino acids that could be incorporated in the optimized solution. The numbers by each of the edges correspond to the LSE costs for choosing a particular tetramer. For this case, the LSE costs have been altered to clearly show the costs of choosing a particular path. The shortest path through the graph is represented by the node sequence (1), (3), (6), (8), (9).

The key step in the process of identifying the minimum LSE is to formulate the problem as a shortest-path network optimization problem. This process can be illustrated using an example sequence having a length of six (6) amino acids, in which there are two possible residues for each of the first two positions in the protein, while the remaining four positions have only a single possibility. The full range of possibilities can be described via the following two sequences: MERLTG and IARLTG. From these sequence, we see that M and I are the two candidate residues for the first position, E and A are the candidates for the second position, while the third, fourth, fifth, and sixth positions are R, L, T, and G, respectively. The network consists of nodes connected by directed arcs, which encodes all possible proteins for this example along with the LSE associated with each. The nodes are arranged in stages, as illustrated in FIG. 4. Stage i contains nodes labeled by a quintuple (i,a(i,1),a(i,2),a(i,3),a(i,4)) where (a(i,1),a(i,2),a(i,3),a(i,4)) spans the full set of possible tetramers for positions i, i+1, i+2, i+3 in the sequence. For example, as can be seen in FIG. 4, there are four possible tetramers in positions 1, 2, 3, 4 in our example problem, namely, MERL, IERL, MARL, and IARL, so stage 1 of the network contains nodes corresponding to each of these four possibilities. The arcs in the network consist of links from nodes at stage i to nodes at stage i+1, where two nodes are joined if they represent overlapping tetramers. Specifically, there is an arc from node (i,a(i,1),a(i,2),a(i,3),a(i,4)) to node (i+1,a(i+1,1),a(i+1,2),a(i+1,3),a(i+1,4)) if a(i,2)=a(i+1,1) and a(i,3)=a(i+1,2) and a(i,4)=a(i+1,3), that is, if the last three residues in the tetramer at stage i are identical to the first three acids in the tetramer at stage i+1. The length of each arc is defined to be the entropy associated with the tetramer at its destination node. The network is completed by adding a source node prior to stage 1, with arcs to all the nodes at stage 1, and a sink node after the last stage, with arcs from all nodes in the last stage.

Construction of this graph can be performed efficiently from a list of homologous sequences by taking advantage of the stage-wise structure, in particular, the fact that nodes at a stage (i) can be connected only to nodes at stage i+1. Utilizing this property, the complexity of assembling a graph of K nodes from O(K²) to O(K) is reduced. The number of nodes (K) can be bounded by a constant multiple of sequence length n.

The sequence with minimum LSE can now be found by finding the shortest path through the network from the source node to the sink node. By example, at least one embodiment of the invention employs a highly efficient standard algorithm known as Dijkstra's algorithm to assist with finding the shortest path through the network. Once the shortest path is identified, the chimera with optimal LSE can be found by overlapping the tetramers corresponding to the nodes along the optimal path. This process is illustrated for our example problem in FIG. 4.

As with any dynamic programming approach, Dijkstra's algorithm starts by solving a sub-problem, then expands this sub-problem incrementally, modifying the solution at each step, until the solution of original problem is obtained. In the case of Dijkstra's algorithm, each sub-problem consists of a subset of nodes whose shortest path to the source node is known. The trivial subset for the first sub-problem is the source node itself. At each step, this subset is expanded by a single node, by adding the closest node to this source from outside the set of nodes with known distances. The algorithm terminates when the subset encompasses the sink node. The solution is recovered by backtracking along the arcs from sink node to the source node.

Since the algorithm is simple to describe, we now outline details of Dijkstra's approach and demonstrate its application to the given example. Given a directed graph G=(V, E) where V is the set of nodes, E is the set of arcs, and C[ij] is the cost of the edge going from node i to node j, the algorithm maintains a set of node S for which the shortest distance from the source is known. The following steps identify the process.
(1) Initialize S to contain only the source node.
(2) All nodes in the set (V-S) that have a predecessor in S are associated with a “special path” starting at the source node that passes only through nodes in S, whose total length is as short as possible. The special path for every node is stored in an array D, while the predecessor node (in S) on this special path is stored in an array P.
(3) At each step, we add to S a single node from the set (V-S), whose distance from the source (D value) is as short as possible.
(4) The algorithm terminates once all the nodes have been moved to S.
(5) The shortest path for any given node can be determined by tracing the predecessors in P.

Initially, the set S={1} and the D values for the neighboring nodes 2, 3, 4, 5 are D [2]=20, D [3]=10, D [4]=30, D [5]=40. Since nodes 6, 7, 8 and 9 cannot be directly reached from node 1, their distances are set to infinity.

At every iteration of the algorithm, w represents the node that is selected to enter the set S. For example in the first iteration, we select the node w=3 to enter S, since it has the smallest D value. Proceeding to the second iteration, the distances to the neighbors of node 3 in the set (V-S) are updated. Since node 6 is the only such neighbor of node 3, we get D[6]=min(infinity, D[3]+C[3,6])=min(infinity, 10+20)=30. The other distances do not change because there is no way to reach them as part of a path containing node 3. The P number for node 6 i.e. P[6]=3 indicates that node 3 is the predecessor to node 6 on the shortest path from node 1 to node 6. The sequence of D numbers at the end of each iteration is indicated in Table 1 and the final P numbers are given the predecessor array table (Table 2). By tracing the predecessor array backwards from the sink (node 9), one can clearly see that the nodes on the shortest path tracing backwards from sink (node 9) to source (node 1) are {9,8,6,3,1}. The shortest path is shown in FIG. 4. The optimal string is retrieved from the shortest path by stripping out the node stage numbers and merging the tetramers along the path, eliminating overlaps.

By example, the implementation of Dijkstra's algorithm can be in C++ code and utilize the adjacency list representation to store the vertices in V-S. The overall running time for an efficient implementation of Dijkstra's algorithm on a general graph is O(e log v) where v is the number of nodes and e is the number of arcs. For a graph, the value of v in terms of the number of candidate amino acids pᵢ at each stage i is calculated. The number of nodes at stage i equals the total number of possible tetramers starting at position i, which is the product (pᵢ pᵢ₊₁ pᵢ₊₂ pᵢ₊₃). By defining pₙ₊₁=pₙ₊₂=pₙ₊₃=1, the total number of nodes v is obtained by summing (pᵢ pᵢ₊₁ pᵢ₊₂ pᵢ₊₃) over i=1, 2, . . . , n. Note that this quantity is bounded by a constant multiple of sequence length n. A bound on the number of arcs e is obtained by noting that the number of outgoing arcs from any node at stage i is exactly pᵢ₊₃. Hence, the total number of arcs e is at most a factor max_{i=1,2, . . . ,n} pᵢ greater than v, so that e is also bounded by a constant multiple of n. In an alternative embodiment a different algorithmic approach to the shortest path solution can be employed. By example, an alternative algorithm can be selected from the group including dynamic programming, such as the Floyd-Warshall approach, Johnson's shortest path algorithm, Bellman-Ford approach and A* search algorithm approach.

The following represents an alternative embodiment of the present invention, in which the shortest path process is a network flow process having a goal to find a path of minimum cost (or length) from a specified source node (s) to a specified destination node (t). When calculating the solution, let G=(N, A) be a directed network defined by a set (N) of (n) nodes and a set (A) of (m) directed arcs. Each arc (i,j) ε (A) has an associated cost (cᵢⱼ) that refers to the cost per unit flow on that arc. Each node is associated with I ε N an integer number b(i) representing its supply/demand. If b(i)>0, node (i) is a supply node, if b(i)<0, node (i) is a demand node and if b(i)=0 node (i) is a transshipment node.

Specifically, if b(s)=1 and b(t)=−1, and b(i)=0 for all other nodes in the network, the process will send one unit of flow along the shortest path from node (s) to node (t). The decision variables in the shortest path problem are thus arc flows, and the arc flow on an arc (i,j) ε A is represented by xᵢⱼ. A shortest path problem can be mathematically formulated as shown in Equation Set 2 and solved using the Network Symplex Method.

$$min {\sum }_{i ( i , j ) ∈ A} {c}_{ij} {x}_{ij} \\ s . t . {\sum }_{j : ( i , j ) ∈ A} {x}_{ij} - {\sum }_{j : ( j , i ) ∈ A} {x}_{ji} = 1 , i \\ {\sum }_{j : ( i , j ) ∈ A} {x}_{ij} - {\sum }_{j : ( j , i ) ∈ A} {x}_{ji} = - 1 , i \\ {\sum }_{j : ( i , j ) ∈ A} {x}_{ij} - {\sum }_{j : ( j , i ) ∈ A} {x}_{ji} = 0 , other ; \\ {x}_{ij} \geq 0 , ∀ ( i , j ) ∈ A \qquad Equation Set 2$$

A protein sequence can be segmented as a series of overlapping four-amino acid segments. Where the sequence has (n) residues there would be (n-3) segments with each segment containing just one node if the residue is conserved in a given position and more nodes otherwise. A node in the network was uniquely represented by a pentuple, a combination of the segment number and four amino acids in every overlapping sub-sequence. The precedence among the nodes was then dynamically determined using the fact that a node (i) precedes node (j) if the segment number of node (j) is equal to the segment number of node (i) plus one and if the last three amino acids of the sub sequence in node (i) match the first three amino acids of the sub sequence in node (j).

By example, a hypothetical sequence MNLVIA is generated. Based on the rules identified above, the series of pentuples (1,M,N,L,V), (2,N,L,V,I) and (3,L,V,I,A) represent the hypothetical sequence. (1,M,N,L,V) precedes (2,N,L,V,I) and (2,N,L,V,I) precedes (3,L,V,I,A). Given 2 sequences MNLVIA and MNLKIA, having a variable residue in position four, the pentuples are given by: (1,M,N,L,V), (1,M,N,L,K), (2,N,L,V,I), (2,N,L,V,K) and (3,L,V,I,A) and (3,L,V,K,A). The variable residue in position four has the effect of doubling the total number of nodes. Identifying the sequence with minimum LSE includes generating the nodes and then setting up the source node with a supply of 1 and the destination node with a supply of −1.

Alternatively, the process can be automated when setting up the source node and the destination node, and padding the given sequences with a hypothetical amino acid sub string “XXXX” on the left and the right hand side. Therefore, in the above example, MNLVIA would end up being XXXXMNLVIAXXXX with the source node being the pentuple (1,X,X,X,X) and the sink node being the pentuple (11,X,X,X,X). Although this has the disadvantage of adding extra nodes, it ensures that there is always a single source single sink shortest path problem. Without these extra nodes there would likely be a multi source and/or multi sink shortest path problem if the first and/or the last position in the sequence has a variable residue.

### Experimental Validation

The effectiveness of at least one embodiment of the invention was tested on a commonly studied enzyme. Adenylate kinase (AK) sequences of the adenylate kinases from a thermophile, Bacillus stearothermophilus (AK thermo), a mesophile, Bacillus subtilis (AK meso) and a psychrophile, Bacillus globisporus (AK psychro) were utilized. Despite the differences in the thermal stabilities of the identified adenylate kinase sequences, the protein sequences were found to be approximately 70% identical and each three-dimensional structure is similar.

A more thermostable protein was designed by substituting residues in the AK meso with residues in AK psychro. Though mesophilic sequences are more stable than psychrophilic sequences, a psychrophilic sequence was used for the substitutions instead of the more stable thermophilic sequence. For purposes of experimentation, Nature's adaptations for higher stability were not utilized, therefore more effectively and robustly evaluating various embodiments of the present invention. Mutations in the protein sequences were only chosen from pre-selected domains of the proteins. In this case, the CORE domain was chosen. Referring to Sequence Listing 1, a sequence listing is provided comparing the AK thermo, AK meso, AK psychro, AK LSE1, AK LSE2, and AK LSE3. The CORE domain is identified along with the substitutions for each of the AK LSE sequences (AK LSE1, AK LSE2, AK LSE3). Mutations were not chosen outside of the CORE domain based upon biochemical studies indicating mutations in the non-CORE regions not displaying changes in thermostability. In an alternative embodiment regions for substitutions are automated based upon a set of rules for the particular target protein sequence. Automated identification of allowable substitutions includes identifying the allowable locations for substitution as well as the actual allowable amino acids for substitution. A list of allowable substitutions can be generated from a phylogenetic analysis and sequence alignment. Based upon the sequence alignment, allowable substitutions can include non-conserved amino acid substitutions. Furthermore, allowable amino acids are chosen based upon the limited effect upon structure and function. Allowable amino acids for substitution can include 1, 2 or 3 different amino acids. Alternatively, greater than 3 amino acids can be allowable at a particular residue substitution location in the protein sequence.

In the CORE domain, AK meso and AK psychro differ in 55 residues. Among the 2⁵⁵ possible variant sequences, a sequence (AK LSE1) having the lowest average LSE was found to have 23 substitutions (see Sequence Listing 1). In AK LSE1, the substitutions are spread over its sequence and do not show particular patterns in the side chain properties, such as polarity and hydrophobicity. A significant number of residues in a psychrophilic homologue were predicted to contribute to thermostabilization of the mesophilic target.

To validate experimentally the result of the LSE optimization, the AK LSE1 protein was produced and its thermostability is measured. A slightly less optimized variant in closely related sequence was also generated having 26 substitutions (see Sequence Listing 1, AK LSE2). This variant has the most substitutions in the top twenty most optimized sequences. Instead of making the variant genes by multiple rounds of site-directed mutagenesis, synthetic genes were utilized. The functional proteins were expressed and purified, followed by determining the melting temperature (Tₘ) values using differential scanning calorimetry. The substitutions in the AK variants resulted in significant stabilization. The Tₘ values of AK LSE1 and AK LSE2 are higher than that of AK meso by approximately 11.6° C. and 12.5° C., respectively. These values were obtained from irreversible denaturation of the enzymes, which is more relevant in industrial settings. The catalytic activities of the variants were also extended to higher temperatures. It was demonstrated that it is not necessary to utilize a thermophilic homologue or even multiple homologous sequences in order to obtain a more thermostable protein. Stable proteins were made by judicious choice of amino acid substitutions from a single less stable homologue with little difficulty. Various residues are conserved between AK thermo and AK psychro but not in AK meso. Of these residues there are approximately five various substitution sites in AK LSE1 and AK LSE2 (residues 17, 69, 73, 105, and 205). To exclude the possibility that the increased stability of these variants is not caused by the optimized LSE, but by the five conserved residues also existing in AK thermo, a third variant was made.

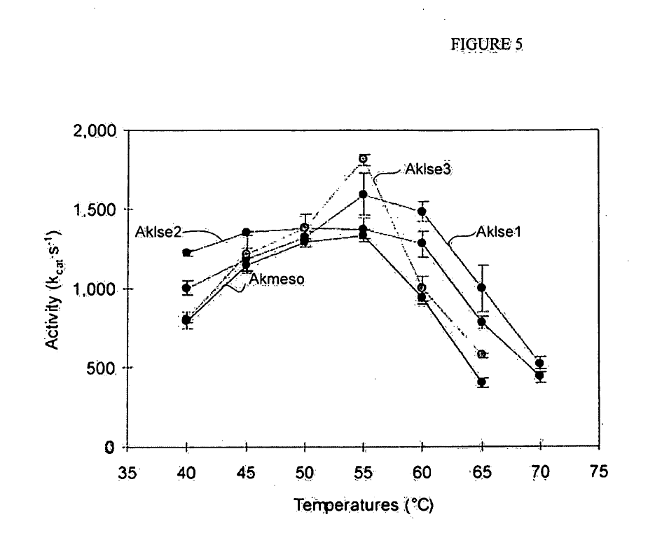

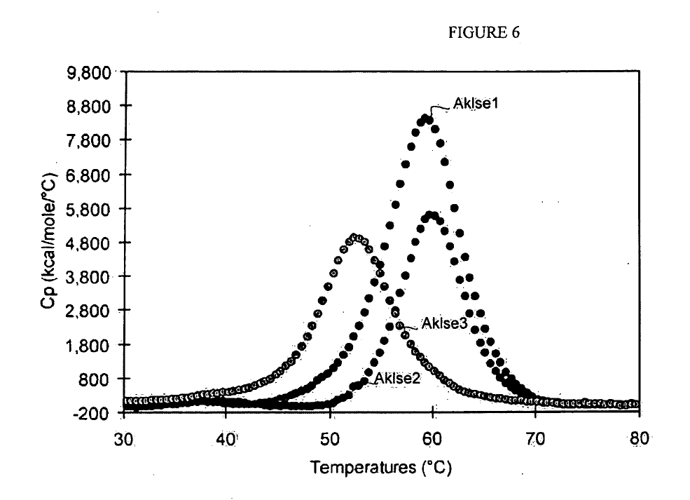

This confirmation experiment allowed the same mesophile to psychrophile substitutions but only in a position where amino acids were different in all three wild type (WT) sequences. There are nineteen residues identified as such, and the LSE calculation resulted in the most optimized sequence (AK LSE3) having ten substitutions (see Sequence Listing 1). Because of significantly smaller search space for an optimal sequence in this experiment than the previous one (2¹⁹ vs. 2⁵⁵), AK LSE3 has a higher average LSE than AK LSE1 and AK LSE2, thereby suggesting smaller stabilization. As expected, the Tₘ of AK LSE3 was lower than those of AK LSE1 and AK LSE2, but still considerably higher than that of AK meso. Now referring to FIG. 5, the AK variants are shown having considerably higher Tₘ values than AK meso from which the variants were designed, but still display a correlation in the plot of Tₘ versus average LSE. As a result there are increases in the stabilities as their LSE values are optimized. FIG. 6 provides a melting curve Tₘ plot for the three AK variants.

Amino acid substitutions are chosen for domains that present the highest likelihood of effecting protein thermostability. Thermostability within these domains is affected by mutations or substitutions of amino acids. By example, the CORE domain for Adenylate Kinase was chosen based upon the effect mutations and substitutions within this domain have upon protein thermostability. In an alternative embodiment, multiple domain regions can be targeted for amino acid substitutions designed to effect protein thermostability.

### Efficiency of Various Embodiments

The brute-force implementation of ICE described in Bae et al. 2008 had two steps: the creation of all the possible sequences given the allowable substitutions, and the average LSE calculation for the generated sequences. The latter step was the rate-limiting step, as it required tetramers to be constantly looked up on a table that was 160,000 lines long. With this embodiment, the most computationally expensive calculation was finding the lowest average LSE value for the variant AKlse3. This sequence had 19 possible mutations and using a Sun Fire X4100 Linux workstation (AMD Opteron Processor, 2.2 GHz, 4.0 Gigs RAM), this algorithm needed 3 hours and 40 minutes to calculate the LSE scores for all the possible mutants. Due to algorithmic limitations, it was unreasonable to perform it using more than 28 allowable substitutions at a time (2²⁸ possible sequences).

Two of the other variants in our previous study had 53 allowable substitutions between the target protein and the homologous sequence. In order for this algorithm to work in a reasonable timeframe, we needed to split the multiple sequence alignment into four manageable segments, the largest of which had 17 mutations. The segments were split into regions where there were at least four conserved amino acids in a row. Because LSE is calculated by examining tetramers, each amino acid influences the LSE values for its three neighboring residues. By splitting the sequence at regions where there were four conserved residues, it ensured that the mutations made in one segment would not influence the mutations in the following segment. We were fortunate that our sequence alignment allowed for the four segments to be isolated and run separately. Had we been unable to split the problem into four segments, running this algorithm with 2⁵³ possibilities would have taken an estimated computation time on the order of millions of years.

The shortest path approach for ICE utilizing Dijkstra's approach dramatically improves the computational cost. Because of the way the nodes are organized, there is no immediate upper-limit on the number of allowable substitutions, and there is no practical limit for how many sequences can be incorporated into the algorithm. The improved embodiment of the algorithm was used to solve a problem with the 19 mutations described above using the same Sun Fire X4100 workstation. Instead of taking 3 hours and 40 minutes, this algorithm arrived at the correct answer in less than a second.

Other tests with the shortest path approach further revealed its computational efficiency. With each test, the length of the sequences, the percent sequence identity, and the number of sequences included are all variables but they can all be compared by counting the total number of nodes in the graph for each of the cases. By example, using the shortest path approach with two sequences that are 67% identical and 4,800 amino acids long will produce a graph roughly the same size as two sequences that are 400 amino acids long and share 0% sequence identity (a ˜6500 nodes). The shortest path algorithm calculated the global minimum in these two cases in less than a second.

Various embodiments of the present invention can be employed for designing a wide variety of proteins. By example, embodiments of the present invention can be used to design hemoglobins for a protein-based blood substitute, myoglobins, polymerases for PCR reactions, and cellulases for improved biomass processing.

The various embodiments are given by example and the scope of the present invention is not intended to be limited by the examples and equations provided herein. Although the invention has been described in detail with reference to preferred embodiments, variations and modifications exist within the scope and spirit of the invention as described and defined in the following claims.

1. A method for designing thermostable proteins using computers, comprising:
identifying a target protein sequence;
identifying at least one homologous sequence of the base protein sequence;
generating a list of conserved residues between the base sequence and homologous sequence;
generating a list of allowable substitution positions based upon function and structure criteria of the base sequence;
generating a list of all possible chimera sequences based upon the allowable substitutions;
calculating a local structural entropy value for each chimera sequence, wherein the chimera sequences are ordered based upon the local structure entropy value; and
selecting a target sequence having a greater thermostability than the base sequence.

2. The method according to claim 1 wherein the target sequence has the lowest local structural entropy of the chimera list.

3. The method according to claim 1 wherein the protein sequences comprise an amino acid sequence greater than 30 amino acids.

4. The method according to claim 1 wherein the allowable substitutions comprise greater than or equal to about 10 amino acids substitutions.

5. The method according to claim 1 wherein the amino acid substitutions are in a range of about 5 percent to about 15 percent of the total target sequence.

6. The method according to claim 1 wherein the allowable substitutions include non-conserved residues.

7. The method according to claim 1 wherein the allowable substitutions are altered based upon a secondary structure of the target sequence.

8. The method according to claim 7 wherein the allowable substitutions are modified based upon a three dimensional structure of a protein.

9. A process for designing a thermostable protein sequence, comprising:
generating a plurality of chimera sequences based upon a comparison of a base protein sequence and a homologous sequence, the plurality of chimera sequences having at least one amino acid substitution as compared to the target sequence;
selecting a target sequence based upon a local structural entropy value (LSE), the target sequence having greater thermostability as compared to the base sequence.

10. The method according to claim 9 wherein the target sequence has the lowest local structural entropy of the plurality of chimera sequences.

11. The method according to claim 9 wherein the target sequence represents a shortest path through a network.

12. The method according to claim 9 wherein the generating is based upon a shortest-path network and individual tetramers represent individual nodes within the network.

13. The method according to claim 1 wherein the allowable substitutions are modified based upon a secondary structure of the target sequence.

14. The method according to claim 12 wherein the allowable substitutions include non-conserved residues.

15. The method according to claim 14 wherein the allowable substitutions are altered based upon a three dimensional structure of a protein.

16. The process according to claim 15, wherein the target sequence maintains substantially the same tertiary structure of the base sequence.

17. A protein sequence identified by a process, at least partially implemented on a computer system, for designing a thermostable protein, comprising:
comparing a base protein sequence to a homologous protein sequence;
generating a list of conserved residues between the target sequence and homologous sequence;
generating a list of allowable substitution positions based upon function and structure criteria of the base sequence;
generating a list of chimera sequences based upon the allowable substitutions;
calculating a thermostability value for each chimera sequence, wherein the chimera sequences are ordered based upon the thermostability value; and
selecting a target sequence from the chimera sequences having an optimal thermostability value.

18. The protein sequence according to claim 17, wherein the protein sequence is selected from the group consisting of AKLSE1, AKLSE2, and AKLSE3.

19. The protein sequence according to claim 17, wherein the protein sequence is selected from a group consisting of globins, cellulases, and polymerases.

20. The protein sequence according to claim 17, wherein the thermostability value is a local structural entropy (LSE) value.

21. The protein sequence according to claim 17, wherein the LSE value is calculated by
$$S = - {\sum }_{j = 1}^{8} {\overline{π}}_{j} ln {\overline{π}}_{j}$$

22. The protein sequence according to claim 20, wherein the process includes a shortest path, network algorithm for efficiently identifying the target protein.

23. A protein sequence identified by a process, at least partially implemented on a computer system, for designing a thermostable protein, comprising:
comparing a base protein sequence to a homologous protein sequence;
generating a list of conserved residues between the target sequence and homologous sequence;
generating a list of allowable substitution positions based upon function and structure criteria of the base sequence;
generating a shortest path optimization in a network, wherein allowable substitutions and the LSE associated with each sequence are represented in the network;
calculating an LSE value for each tetramer within the network; and
selecting a target sequence having an optimal local structural entropy value, wherein the target sequence represents the shortest path through the network.

24. The protein sequence according to claim 23, wherein the sequence is selected from the group consisting of hemoglobins, myoglobins, polymerases, and cellulases.


SEQUENCE LISTING (6 sequences)

SEQ ID NO: 1 - protein, 217 aa, Bacillus stearothermophilus
MNLVLMGLPGAGKGTQAEKIVAAYGIPHISTGDMFRAAMKEGTPLGLQAKQYMDRGDLVPDEVTIGIVRERLSKDDCQNGFLLDGFPRTVAQAEALETMLADIGRKLDYVIHIDVRQDVLMERLTGRRICRNCGATYHLIFHPPAKPGVCDKCGGELYQRADDNEATVANRLEVNMKQMKPLVDFYEQKGYLRNINGEQDMEKVFADIRELLGGLAR

SEQ ID NO: 2 - protein, 217 aa, Bacillus subtilis
MNLVLMGLPGAGKGTQGERIVEDYGIPHISTGDMFRAAMKEETPLGLEAKSYIDKGGLVPDEVTIGIVKERLGKDDCERGFLLDGFPRTVAQAEALEEILEEYGKPIDYVINIEVDKDVLMERLTGRRICSVCGTTYHLVFNPPKTPGICDKDGGELYQRADDNEETVSKRLEVNMKQTQPLLDFYSEKGYLANVNGQQDIQDVYADVKDLLGGLKK

SEQ ID NO: 3 - protein, 217 aa, Bacillus globisporus
MNIVLMGLPGAGKGTQADRIVEKYGTPHISTGDMFRAAIQEGTELGVKAKSFMDQGALVPDEVTIGIVRERLSKSDCDNGFLLDGFPRTVPQAEALDQLLADMGRKIEHVLNIQVEKEELIARLTGRRICKVCGTSYHLLFNPPQVEGKCDKDGGELYQRADDNPDTVTNRLEVNMNQTAPLLAFYDSKEVLVNINGQKDIKDVFKDLDVILQGNGQ

SEQ ID NO: 4 - protein, 217 aa, ARTIFICIAL SEQUENCE
  SYNTHETIC
MNIVLMGLPGAGKGTQAERIVEKYGIPHISTGDMFRAAMKEETPLGLEAKSYIDKGELVPDEVTIGIVRERLSKSDCERGFLLDGFPRTVAQAEALEEILEEMGRPIDYVINIQVDKEELMERLTGRRICSVCGTTYHLVFNPPKTPGICDKDGGELYQRADDNEETVTKRLEVNMKQTAPLLAFYDSKEVLVNVNGQQDIQDVFADVKVILGGLKQ

SEQ ID NO: 5 - protein, 217 aa, ARTIFICIAL SEQUENCE
  SYNTHETIC
MNIVLMGLPGAGKGTQAERIVEKYGIPHISTGDMFRAAMKEETPLGLEAKSYIDKGELVPDEVTIGIVRERLSKSDCERGFLLDGFPRTVAQAEALEELLEEMGRPIDYVINIQVDKEEIIARLTGRRICSVCGTTYHLVFNPPKTPGICDKDGGELYQRADDNEETVTKRLEVNMKQTAPLLAFYDSKEVLVNVNGQQDIQDVFADVKVILGGLKQ

SEQ ID NO: 6 - protein, 217 aa, ARTIFICIAL SEQUENCE
  SYNTHETIC
MNLVLMGLPGAGKGTQGERIVEKYGIPHISTGDMFRAAMKEETPLGLEAKSYIDKGELVPDEVTIGIVKERLGKDDCERGFLLDGFPRTVAQAEALEEILEEMGKPIDYVINIQVDKDVLMERLTGRRICSVCGTTYHLVFNPPKTPGICDKDGGELYQRADDNEETVTKRLEVNMKQTAPLLDFYDEKGYLVNVNGQQDIQDVYADVKVLLGGLKQ